(19) United States
(12) Patent Application Publication
(10) Pub. No.: US 2008/0010085 A1
(43) Pub. Date: Jan. 10, 2008

(54) Method of promoting dental implant and restorative dental services, and related educational services

(76) Inventor: Michael Hahn, Boca Raton, FL (US)

Correspondence Address: MYERS & KAPLAN;INTELLECTUAL PROPERTY LAW, L.L.C., CUMBERLAND CENTER II, 3100 CUMBERLAND BLVD , SUITE 1400, ATLANTA, GA, 30339, US

(21) Appl. No.: 11/481,214

(22) Filed: Jul. 5, 2006

(51) Int. Cl. G06Q 10/00; G06Q 40/00; A61C 13/00; A61C 5/00

(52) U.S. Cl. 705/2; 433/215; 433/167; 705/38

(57) ABSTRACT

A method of promoting dental implant and related educational services. In a typical embodiment, the system includes a third party promoter for coordinating among potential dental patients, dental specialists and dental implant manufacturers. In a typical implementation, the third party promoter can provide information and educational materials to promote the use of dental implants, thereby exposing the dental patients to the availability of dental implants, increasing awareness of dental specialists to offer dental implants as an option to their patients and to increase overall sales of dental implants for dental implant manufacturers.

### BACKGROUND

I. Field of the Invention

The present invention relates generally to the field of dental promotions and more particularly to a method of promoting dental implant and restorative dental services, and related educational services.

II. Description of the Related Art.

In general, dental implants have been sold for more than 25 years and were approved by the FDA in the 1980s. Within the last 10-15 years, technological advances in new surfaces and abutment connections have yielded major enhancements in dental implant results. Healing periods have been shortened from six months to six weeks or in some cases to less than a day. Success rates have increased to 98% and the use of dental implant is becoming a predictable way to restore teeth.

Dental implants are simply replacement tooth roots. They provide a strong foundation for permanent or removable replacement teeth. Natural tooth color is matched identically to the dental implants. There are many advantages to dental implants according to WebMD, they include:

Made of titanium prosthetic posts, dental implants are placed into the bone of the upper or lower jaw to act as a replacement for the root portion of lost natural teeth. These implants also serve as an anchor for replacement teeth.

In general there is a 97% success rate with dental implants, depending on where in the jaw the implants are placed. And, implants can last a lifetime with the proper care. Everyone with healthy gums and strong bones can choose this dental option but they must be willing to commit to good oral hygiene and regular dental visits for them to last.

To put it in similar terms, anyone healthy enough to undergo a routine dental extraction or oral surgery can be considered for an implant procedure.

Once the decision has been made to go forward with tooth root implants a small titanium post is placed into the bone socket of the missing tooth. The jawbone grows around the implanted metal post as it heals, anchoring it securely in the jaw. The typical healing process time is 6 to 12 weeks.

When the implant has bonded to the jawbone an abutment (a small connector post) is attached securely to hold the new tooth in place. Impressions of the patient's teeth are made in advance of this procedure that capture all of the patient's teeth, their type and arrangement, including the bite; the new tooth or teeth are based on this model. A crown, often referred to as a replacement tooth, is then attached to the abutment.

Some patients may have attachments placed on the implant, instead of one or more individual crows, that retain and support a removable denture. The color of the patient's new teeth is matched with their natural teeth. Replacement teeth look, feel and function identically to the patient's own natural teeth because the implants are secured within the jawbone.

As mentioned earlier in this report, in 2003 the U.S. market for dental implants and the posts to which a prosthetic tooth is attached, called abutments, was valued at $270 million. According to research, the dental implant market is predicted to continue growing substantially through the year 2008.

A new and evolving area of applied dentistry, Implantology, is designed to incorporate elements of traditional dental disciplines such as periodontics, prosthodontics, and oral surgery. Bone augmentation and regeneration techniques have radically expanded the possibilities for implant-based restorative dentistry, and have provided dental practitioners with a variety of sophisticated tools to improve the efficacy of traditional implantation procedures and limit their potential long-term morbidity.

Yet with all these improvements, the dental implant market is only at a 5-6% penetration rate according to the implant manufacturers. Sales continue to grow at a rate of 15-20% per year accounting for a $400-$450 million market in 2004. This represents approximately 1.0-1.2 million implants sold by 40 manufacturers.

The Journal of the Indiana Dental Association reported in 2002 that three out of four patients would restore missing teeth with implants regardless of cost if they were properly educated on their procedures and benefits. This suggests there is a very large opportunity to increase dental implant procedures.

The dental implant market in the U.S. is a very large and relatively untapped market. The general public does not understand the benefits and effectiveness of implants as an alternative treatment for missing or bad teeth. It is estimated that 100 million Americans have one or more missing teeth. Furthermore, a majority of dentists do not currently utilize or view implants as viable services with their practices. In fact many conventional dentists have not received training in cosmetic and implant dentistry and therefore do not fabricate their own crowns for their patients. Furthermore, crowns and other bridge and veneer work can leave imperfections on the natural tooth into which bacteria can enter and ultimately decay the tooth. Crowns also require reducing the natural tooth to apply. As such, the natural tooth can fail over time and total tooth loss in the location can occur. Therefore, the untapped implant dentistry market has great advantages over much conventional dentistry. Implant dentistry therefore has large unrealized growth potential in the dental industry. Typically, major dental implant manufacturers are focused on trying to improve their sales and market share. As such, they can have limited affect on the overall implant market. Furthermore, there is little marketing coordination between dental specialists who could provide implants to dental patients and dental implant manufacturers. Furthermore, there are virtually no direct marketing efforts made by dental implant manufacturers to dental patients.

### SUMMARY

In general, the invention features a method of promoting dental implant and related educational services. In general, the method includes providing third party as a ‘neutral’ source of information to the consumer market and the de facto independent expert guide to prospective patients. In a typical implementation, the method can also provide valuable promotion services to the implant manufacturers and the dental profession. In a typical embodiment, the system includes a third party promoter for coordinating among potential dental patients, dental specialists and dental implant manufacturers. In a typical implementation, the third party promoter can provide information and educational materials to promote the use of dental implants, thereby exposing the dental patients to the availability of dental implants, increasing awareness of dental specialists to offer dental implants as an option to their patients and to increase overall sales of dental implants for dental implant manufacturers.

In general, in one aspect, the invention features a method for promoting dental implant services, including identifying a group of dental patients requiring a dental service, selecting a subset of the persons requiring the dental service who are candidates to receive dental implants, distributing information relating to dental implants to the persons requiring the dental service and promoting the use of dental implants to the group of dental patients.

In one implementation, the method further includes actively pursuing the subset of persons requiring the dental service who are candidates to receive dental implants.

In another implementation, the dental service is the fitting of a crown.

In another implementation, the dental service is the fitting of dentures.

In another implementation, the dental service is veneer work.

In another implementation, the method further includes identifying a group of dental specialists who are able to provide the dental service to the dental patients.

In another implementation, the method further includes identifying a group of dental implant manufacturers who could provide dental implants to the group of dental patients and to the group of the specialists.

In another implementation, the method further includes forming a network that can be accessed by the group of dental patients, the group of dental specialists and the group of dental implant manufacturers.

In still another implementation, the method further includes coordinating between the group dental implant manufacturers and the group of dental patients.

In yet another implementation, the method further includes coordinating between the group dental implant manufacturers and the group of dental specialists.

In another implementation, the method further includes coordinating between the group dental specialists and the group of dental patients.

In another aspect, the invention features a dental implant promotion system, including a network of dental specialists, a network of dental implant manufacturers, a network of dental patients, a third party dental implant promoter, wherein the third party promoter is for coordinating the network of dental specialists, the network of dental implant manufacturers, and wherein the third party promoter is for coordinating the network of dental specialists and the network of dental patients.

In one implementation, the third party dental implant promoter provides dental implant information to the network of dental patients.

In another implementation, responses generated by a subset of the network of dental patients are received by the third party dental implant promoter.

In another implementation, it is determined whether or not the subset of the network of dental patients is in need of dental implants.

In another implementation, the third party promoter coordinates a visit between a subset of the network of dental specialists and the subset of dental patients.

In still another implementation, the subset of dental specialists determines the need for a dental implant for the subset of dental patients.

In yet another implementation, the third party promoter can coordinate contact between the subset of dental specialists and a subset of dental implant manufacturers.

In another implementation, the subset of dental specialists can receive a dental implant from the subset of the dental implant manufacturers to provide to the subset of dental patients in need of the dental implant.

In another implantation, dental implant information is provided through a global network.

In another implementation, the third party promoter can coordinate dental implant marketing between the network of dental patients and the network of dental implant manufacturers.

In another implementation, coordinate communication between the network of dental patients and the network of dental specialists if the third party promoter determines a need in the network of dental patients for dental implants.

In another implementation, the dental implants provided to the network of dental patients are provided from the network of dental manufacturers via the network of dental specialists.

In another implementation, the third party promoter can coordinate enhanced communication between the network of dental patients and the network of dental specialists to promote the use of dental implants for the network of dental patients.

In another aspect, the invention features a method for promoting restorative dental services, comprising identifying a group of prospective patients who want restorative dental services, selecting a subset of the group of prospective patients who want restorative dental services who qualify for a dental line of credit, selecting a subset of the group of prospective patients who want restorative dental services who are candidates to receive implant supported dental services, providing information about restorative dental services to the group of prospective patients who want restorative dental services, providing interdependent dental network access to the group of prospective patients who want restorative dental services and promoting the use of implant supported dental services to the subset of the group of prospective patients who are candidates to receive implant supported dental services.

In one implementation, the method further includes actively offering services to the group of prospective patients who want restorative dental services.

In another implementation, the restorative dental service is selected from the group consisting of related preparatory services, the orthodontic moving of a tooth, build-up of a tooth, reduction of a tooth to receive a removable appliance, and reduction of a tooth to receive a fixed appliance.

In another implementation, the restorative dental service is the delivery of a fixed appliance selected from the group consisting of a coping, an inlay, an onlay, a veneer, a crown or a bridge.

In another implementation, the restorative dental service is the delivery of a removable appliance selected from the group consisting of a partial denture, a complete denture, and an over-denture.

In another implementation, the implant supported dental service comprises related preparatory services selected from the group consisting of the placing of a dental implant, and subsequent fixation and preparation of an implant abutment to receive a fixed or removable appliance.

In another implementation, the method further includes identifying a group of dentists who are qualified and able to provide restorative dental services to the group of prospective patients who want restorative dental services.

In another implementation, the method further includes identifying a group of dentists who are qualified and able to provide the implant supported dental services to the subset of the group of prospective patients who are candidates to receive implant supported dental services.

In another implementation, the method further includes identifying a group of dental laboratories who are qualified and able to provide tooth supported or implant supported dental hardware to the groups of dentists and the group of prospective patients who want restorative dental services.

In another implementation, the method further includes identifying a group of dental core manufacturers who can provide dental core hardware to the group of dental laboratories, the groups of dentists and the group of prospective patients who want restorative dental services.

In another implementation, the method further includes forming the interdependent dental network access to the groups of prospective patients who want restorative dental services, the groups of dentists who are qualified and able to provide restorative dental services, the group of dental laboratories who are qualified and able to provide restorative dental hardware, the group of dental core manufacturers who could provide dental core hardware, and the group of dental implant manufacturers who could provide dental implant hardware.

In another implementation, the method further includes identifying a group of dental implant manufacturers who could provide dental implant hardware to the group of dental core manufacturers, the group of dental laboratories, the groups of dentists and the subset of the group of prospective patients who want implant supported dental services.

In another implementation, the method further includes coordinating between the groups of prospective patients who want restorative dental services and the groups of dentists who are qualified and able to provide tooth supported or implant supported dental services.

In another implementation, the method further includes coordinating between the groups of dentists and the group of dental core manufacturers.

In another implementation, the method further includes coordinating between the groups of dentists and the groups of dental laboratories.

In still another implementation, the method further includes coordinating between the groups of dentists and the group of dental implant manufacturers.

In yet another implementation, the method further includes coordinating between the group of dentists and the group of dental core manufacturers.

In another implementation, the method further includes coordinating between the group of dental core manufacturers and the group of dental laboratories.

In another implementation, the method further includes coordinating between the group of dental laboratories and the group of dental implant manufacturers.

In another aspect, the invention features an implant supported dental service promotion system, including a network of dental implant manufacturers, a network of dental core manufacturers, a network of dental laboratories, a network of dentists, a network of dental line of credit lenders, a network of prospective patients, a third party restorative and implant supported dental service promoter, wherein the third party promoter is for coordinating the network of dentists, the network of dental laboratories, the network of dental core manufacturers, the network of dental implant manufacturers, wherein the third party promoter is for coordinating training of the network of dentists, the network of dental laboratories, and wherein the third party promoter is for coordinating the network of dentists and the network of prospective patients.

In one implementation, the third party dental implant promoter provides dental restorative and dental implant information to the network of prospective patients.

In another implementation, the responses generated by the subsets of the network of prospective patients are received by the third party dental restorative and dental implant promoter.

In another implementation, the third party promoter coordinates a review of credit worthiness between the network of dental line of credit lenders and a prospective patient from the network of prospective patients.

In another implementation, the third party promoter and the network of dental line of credit lenders issue a patient network credit card, respectively to a prospective patient from the network of prospective patients.

In another implementation, the third party promoter coordinates visits between the network of dentists and the prospective patient.

In another implementation, the network of dentists determines a need for dental restoration and dental implants for the prospective patient.

In another implementation, the prospective patient selects a dentist from the network of dentists.

In another implementation, the dentist presents alternative treatment plans for the prospective patient.

In another implementation, the patient accepts a treatment plan presented by the dentist.

In another implementation, the prospective patient swipes the patient network credit card at the office of the dentist.

In another implementation, the third party promoter coordinates between the network of dentists and the network of dental laboratories.

In still another implementation, the third party promoter and the network of dental line of credit lenders issue the network of dentist a dentist network credit card that is valid for purchases exclusively within the network.

In yet another implementation, the third party promoter coordinates contact between the network of dental laboratories and the network of dental implant manufacturers.

In another implementation, the third party promoter and the network of dental line of credit lenders issue the network of dental laboratories a dental laboratory network credit card valid for purchases exclusively within the network.

In another implementation, the third party promoter coordinates contact between the network of dentists and the network of dental core manufacturers.

In another implementation, the third party promoter can coordinate contact between the network of dentists and the network of dental implant manufacturers

In another implementation, the dentist specifies and pays for dental implant hardware from a network dental implant manufacturer providing the hardware to the dentists treating the patient.

In another implementation, the dentist uses the network credit card to specify and pay for dental implant hardware from a network dental implant manufacturer providing dental implant hardware to the dentist treating the patient.

In another implementation, the dentist can specify and pay for dental restorative hardware from a network dental laboratory providing the hardware to the dentist treating the patient.

In another implementation, the dentist can use the dentist network credit card to specify and pay for dental restorative hardware from a network dental laboratory providing the hardware to the dentist treating the patient.

In another implementation, the dentist can specify and pay for dental core hardware used by a network dental laboratory providing dental restorative hardware to the dentist treating the patient.

In another implementation, the dentist uses the network dentist credit card to specify and pay for dental core hardware used by the network dental laboratory providing dental restorative hardware to the dentist treating the patient.

In another implementation, the network dental laboratory specifies and pays for dental implant abutment hardware from a network dental implant manufacturer providing the hardware to the laboratory and the dentist treating the patient.

In another implementation, the network dental laboratory uses the dental laboratory network credit card to specify and pay for dental implant abutment hardware from a network dental implant manufacturer providing the hardware to the laboratory and the dentist treating the patient.

One advantage of the invention is that promoting dental implants results in more patients with improved tooth appearance.

Another advantage of the invention is that promoting dental implants results in more patients with improved speech by reducing patients needing dentures that can slip within the mouth causing mumbling or slurring of words.

Another advantage of the invention is that promoting dental implants results in more patients with improved comfort.

Another advantage of the invention is that promoting dental implants results in more patients that can eat easier.

Another advantage of the invention is that promoting dental implants results in more patients with improved self-esteem.

Another advantage of the invention is that promoting dental implants results in more patients with improved oral health because natural teeth do not have to be reduced therefore resulting in reduced bone-loss.

Another advantage of the invention is that promoting dental implants results in more patients with easier access between their teeth, improving the oral hygiene.

Another advantage of the invention is that promoting dental implants results in more patients with increased durability in their dental work.

Another advantage of the invention is that it creates public awareness about the possibility of dental implants.

Another advantage of the invention is that it can train doctors about dental implants how to restore them with a crown.

Another advantage of the invention is that an increase in public awareness of implants can cause increased demand and thereby lower surgery implant fees.

Another advantage of the invention is that dental patients can have increased access to the convenience of dental implants that is not associated with other dental devices such as dentures.

Another advantage of the invention is that it provides access to improved aesthetics and function via dental implants.

Another advantage of the invention is that it provides prevention of bone resorption via dental implants.

Another advantage of the invention is that it provides a longer life cycle of dental work via dental implants.

Another advantage of the invention is that it provides increased comfort via dental implants.

Another advantage of the invention is that it provides less damage to healthy teeth via dental implants.

Another advantage of the invention is that dental implant manufacturers can provide greater product access to the dental patient community.

Another advantage of the invention is that dental specialists can have greater access to dental implants and dental implant information to provide to their dental patients.

Another advantage of the invention is that dental specialists can have a greater awareness of dental implants and associated advantages as an option for their dental patients.

Another advantage of the invention is that it provides a third party promoter from coordinating between dental manufacturers and dental patients.

Another advantage of the invention is that it provides a third party promoter from coordinating between dental manufacturers and dental specialists.

Another advantage of the invention is that it provides a third party promoter from coordinating between dental specialists and dental patients.

Another advantage of the invention is that promoting dental implants results in more patients with improved blood parameters.

Another advantage of the invention is that promoting dental implants results in more patients with improved diets because edentulous people eat fewer vegetables and dietary fiber that results in increased risk for cancer, cardiovascular disease and stroke.

Other objects, advantages and capabilities of the invention are apparent from the following description taken in conjunction with the accompanying drawings showing the preferred embodiment of the invention.

### BRIEF DESCRIPTION OF THE DRAWINGS

FIG. 1 illustrates an overall system level diagram of a dental implant promotion system.

### DETAILED DESCRIPTION

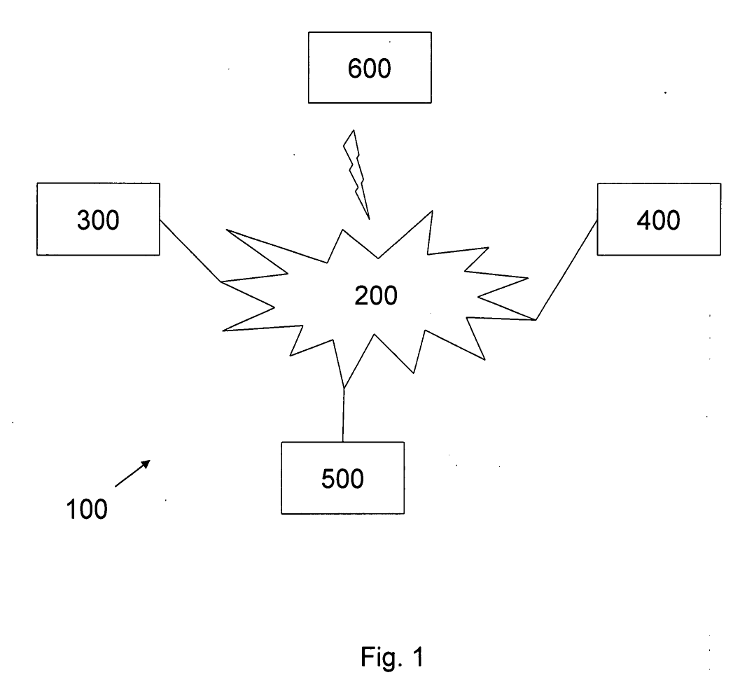

Referring to the drawings wherein like reference numerals designate corresponding parts throughout the several figures, reference is made first to FIG. 1 that illustrates an overall system level diagram of a dental implant promotion system 100. In general, a typical embodiment, system 100 includes network 200, which can be a global network such as the Internet. In another embodiment, network 200 can be a virtual network formed by several different communication media such as, but not limited to electronic communications, telephonic communications, television and radio communications, referrals, bulk mail and the like. It is understood that network 200 can comprise various communication media that can be used to bring smaller sub-networks of groups together for a common interest or cause, the sub-networks now being described.

As such, the system 100 can further include first sub-network or group 300, second sub-network or group 400 and third sub-network or group 500, groups 300, 400, 500 all being connected to network 200. System 100 further typically includes third party promoter 600 connected to network 200. In general, third party promoter 600 coordinates among groups 300, 400, 500.

In a typical embodiment, group 300 represents a group of potential dental patients, typically in need of some dental work, such as dentures, bridges crowns and the like. Group 400 typically represents a group of dental specialists who provide the dental services to group 300. Group 500 typically represents a group of dental implant manufacturers who desire to increase the marketability of dental implants that they offer and expose the need for dental implants to those patients in potential need of the dental implants such as group 300.

Third party promoter 600 can coordinate among groups 300, 400, 500. In one implementation, third party promoter can coordinate between group 400 and group 500, that is, between the dental specialists and the implant manufacturers thereby giving access to the dental implant manufacturers to the dental specialists such that the dental specialists can become aware and educated on the potential patients who may benefit from the implants. As such, in this way, third party promoter 600 offers an intermediate position between the dental specialists and the dental implant manufacturers to benefit both parties. The dental specialists benefit because they are informed and educated on new options for their patients. The dental implant manufacturers benefit because they are given a new marketing channel directly to the dental specialists.

In another implementation, third party promoter 600 can coordinate between group 300 and group 500, that is, between the dental patients and the implant manufacturers thereby giving access to the dental implant manufacturers directly to the dental patients such that the dental patients can themselves become aware and educated on the potential benefits that they may realize by dental implants. Third party promoter 600 can then further coordinate between groups 300, 400, that is, the dental patients and the dental specialists.

Therefore, in another implementation, third party promoter 600 can coordinate between group 300 and group 400, that is, between the dental patients and the dental specialists, thereby providing a direct referral of a dental specialist to a dental patient, with the specific goal in mind to provide to the dental patient, who has been educated on dental implants by a dental implant manufacturer, a dental specialist, who is also well-informed and educated on dental implants. It is further understood that the dental patient can have direct access to a dental specialist, by-passing the dental implant manufacturer, via network 200 and third party promoter 600.

Therefore, it is appreciated that a well-coordinated network 200, via third party promoter 600 can provide an “ambassador” among the three groups 300, 400, 500, that are typically in an alienated relationship among one another.

Third party promoter 600 can therefore increase the flow of implant candidates into dental offices around the country by partnering with both dental specialists and the implant manufacturers driving their volume upwards by increasing the knowledge of the edentulous population, ultimately improving their overall quality of life.

Third party promoter 600 can use network 200 as marketing and educational medium geared towards the edentulous population. Specialized network 200 among dental patients, dental specialists and dental implant companies typically begins with educational marketing to potential implant candidates providing them with the information they need in order to truly see and understand the benefits of dental implants. This knowledge guides them to contact a specific dental specialist in their area. The specific dental specialist, in turn, provides dental implant treatment that is linked to a specific dental implant third party promoter. It is appreciated, as further described above, that all groups 300, 400, 500 all benefit from the implementation of third party promoter 600 via system 100. System 100 therefore, provides a medium in which more of the edentulous population receive an improved quality of life, the dental specialists receive a greater number of implant candidates and the implant companies increase their volume.

As mentioned above, traditionally dental implant companies market their products to dental specialists, rather than directly targeting the edentulous population. By utilizing third party promoter 600, dental implant manufacturers are able to target potential implant patients, who end up referred to a dental specialist using an implant system provided by the same dental implant manufacturer who has networked to the patient via the third party promoter 600 via system 100. As such, dental implant manufacturers have control over which implant system was being used in a particular office and which office those patients where choosing to see for their implant treatment.

Third party promoter (an ambassador to the public) is able better educate the public about the benefits of dental implants with a non-biased approach. The non-biased education, typically via network 100, as describe further below, helps to increase the public's awareness of the benefits of dental implants. The increased awareness leads to a greater demand of dental implants from dental implant manufacturers via network 100.

In general, in a typical embodiment, system 100 provides a specialized network that allows the direction of potential dental patients to specific dental specialists in specific geographic locations. Therefore, third party promoter 600 via network 100 drives dental patient flow to the dental specialists. This flow is in contrast to mere implant sales to the dental specialists, which lacks the synergistic effects realized via system 100 that provides networking among all groups 300, 400, 500. System 100 therefore also indirectly drives the flow of implant sales. Third party promoter 600 typically provides a venue in which partnering between dental specialists and implant companies who want their doctors to be associated with this network can occur. System 100 further provides for marketing to the public and driving potential patients through this network. In a typical implementation, information can be provided and distributed through multimedia including the Internet, magazines, TV commercials, TV infomercials, radio and the like. Therefore, it is appreciated that network 200 is a multimedia network.

Understanding treatment possibility in conjunction with patient behavior a third party promoter can create TV commercials, Infomercials and websites dedicated to help people the understanding of a healthy oral environment and therefore an overall better health. In one embodiment, financial assistance can also be made available to the patients. For example, an instant credit approved process can be applied so that the patients who have been educated about dental implants via network 100 can afford a dental implant.

Traditionally the key players have been the implant manufacturers and the dental specialists. By coordinating in network 200, third party promoter 600 can focus on the traditional two players, while adding the edentulous population, that is, the potential dental patient base, as being the center point of system 100. In this way, system 100 dries the dental patients to create the wave of demand. By this demand being driven, system 100 further allows dental implant manufacturers to be available to deliver the implants and dental specialists are available to place the implants.

Acting as the middle man, third party promoter 600 creates an unbiased approach to the education and information available via network 200. In a typical implementation, third party promoter 600 does not have an interest in which implant is being placed. Third party promoter's 600 primary focus is educating the edentulous population to the point of taking action (visiting a dental professional in the network in order to increase their quality of life). Dental implant manufacturers are then typically encouraged and enticed to join network 200 so that they give their dental specialists the opportunity at being chosen in network 200 and subsequently by patients in network 200.

As discussed shortly above, implant companies don't market directly to the public for several reasons. For example, there is a credibility issue when an implant company tries to educate the public. Therefore, a third party such as the third party promoter can be more believable. Another reason that implant companies do not like to market directly to the public is because the investment is not worth the return. Their investment would benefit all implants and not just their own.

Dental implant manufacturer marketing directly to the dental specialist can be cost ineffective. The costs typically include materials, direct marketing campaigns, salary of rep, education for referring dentists, and education for staff. In order for a dental specialist to grow their implant practice (in turn buy more implants) they typically need to educate their referrals to increase their knowledge, which, in turn, can increase the number of patients referred to the dental specialist. This process can be tedious and expensive and may or may not achieve the desired results. Further, as discussed above, most dentists do not recommend implants to their edentulous patients.

Therefore, third party promoter 600 can also be used to educate the patients and encourage them to operate via network 200 to a dentist specialist who works with implants, which benefits all groups 300, 400, 500 within network 200. System 100 therefore fosters patients with prior knowledge who can ask more educated questions. Therefore, system 100 provides patients more willing to accept implant treatment, and the dental specialists more willing to provide the dental implant service. Therefore, system 100 creates the demand for dental implants first, thereby forcing the dental specialists who typically don't recommend implants (due to lack of education) to educate themselves, providing their patients with enhanced dental care that now includes the option of dental implants.

In a typical implementation, third party promoter 600 can approach dental implant manufacturers in order to obtain contracts based on driving business to their customers, ultimately driving implant sales. In another implementation, third party promoter 600 can also go directly to dental specialists, in order to reach a greater number of dental specialists across the country. Third party promoter 600 can then move patients through network 200, tracking the dental specialists who are being used and which implant manufactures are being benefited. In this way, in one embodiment, third party promoter 600 can have a method to track potential commissions to third party promoter 600. Profit for third party promoter, dental specialists and dental implant manufacturers can be generally increased because the dental specialists in network 200 are educated via network 200 with the capability to handle the increased patient flow. The information and education available to the dental specialists via network 200 allows a transition through the inertia of accepting new technologies. Education is particularly important in the dental implant market because all groups 300, 400, 500 have to understand the products they are using and how to use them correctly for optimal results.

In a typical embodiment, third party promoter 600 can focus on a large and rapidly growing dental implant market in segments. As discussed above, third party promoter 600 can educate the public about the benefit of dental implants and connect them with dental specialists and doctors in their area to perform the procedures. Third party promoter 600 can also connect implant manufacturers with the surgical and restorative dentists.

In general, as further discussed third party promoter 600 can position itself as the ambassador to the public for implant manufacturers and surgical and restorative dentists. Third party promoter 600 can create greater public awareness and education about dental implants. Third party promoter 600 can advertise and promote extensively on TV using commercials and Infomercials, as one aspect of network 200. Third party promoter 600 can also advertise and promote on the Internet, through its own web site and other website, which can include individual dental implant manufacturer websites and dental specialist websites. In one implementation, interested parties in the developing segment are able to place a toll-free call to a call center that will answer their questions and direct them to a qualified dental specialist close to them. In other implementations, online services can also be available such as through text messaging. Through such toll-free numbers and web-site access, prospective patients can have their questions regarding implants answered. Similar educational materials can be available on its web site via network 200.

As such, even in smaller developing segments, which can be third world countries, Third party promoter 600 can build a large and profitable business by bringing together the implant manufacturers, dentists and the public to increase the number of dental implant procedures.

In addition, particularly in a developing segment, third party promoter 600 can provide the prospective dental patient a list of dental specialists close to them that are qualified to perform the procedures. In another implementation, as discussed above, instant financing can e available to the prospective patient. In one embodiment, third party promoter 600 can issue the patient a smartcard that they can use with the provider. In a typical implementation, the smartcard can be a prepaid card that has added value via network 200 that is available to the dental specialist providing the service. The smartcard can also control the patient flow and the dental implants that are used. The smartcard can allow the patient to use a dental specialist within the referral base. Third party promoter can provide other immediate financing options for the patient.

Therefore, financing directly through the network is possible. In one implementation, a single cash card can be linked to several chains of purchase and communication in the network. For example, a single cash card can be used to finance dental services offered in a dentist's office as well as financing for the implants from the manufacturer. In addition, the third party promoter can monitor the chain of events involved in the financing card in order to track commissions. For example, the third party promoter can keep track of those patients who have been issued financing and actually monitor to see if the financing has been used. If the financing has been used, the third party promoter can keep a record of that use to know if the third party promoter is entitled to a commission for that use. In this way, the financing options can also be used as a cross marketing tool for all parties involved: third party promoter; surgeon, restorative dentist, laboratory, patient; implant manufacturers and the like.

As further discussed above, in smaller developing segments, a large number of dental specialists may not currently deal with dental implants. Therefore, third party promoter 600 can also provide educational materials to the dentists and their staffs designed to eliminate their concerns and fears about introducing dental implants into their practices.

In a typical implementation, third party promoter 600 can receive a referral fee from both the dental implant manufacturer and the dental specialist for every patient procedure resulting from its introduction of the patient. In this way, profit can be quickly realized by all groups 300, 400, 500 in a developing segment.

In a typical implementation, third party promoter 600 can market through a variety of multimedia, as illustrated as network 200, that includes but is not limited to: TV advertisements and infomercials the Internet; websites; and presentations at professional dental association meetings.

The third party promoter 600 can match prospective dental implant patients with qualified dentists close to them. Third party promoter 600 provides education and informational material, answers questions, and generally assists a prospective patient as they evaluate the applicability of dental implants to themselves. Third party promoter 600 can also provide educational training materials and services to dentists and their office staff who are not yet utilizing implants in their practices.

Third party promoter's growth opportunities within system 100 can be varied. First, third party promoter can launch its services and begin to attract prospective implant patients. Third party promoter 600 can also develop relationships with primary implant manufacturers to feature their products to the patients and the dentists. Third party promoter 600 can build a solid patient referral history which can increase the number of patient within network 200. As the third party promoter 600 expands network 200, it can introduce additional services and products. As discussed above, one of the products can be an ‘instant’ financing option that third party promoter 600 can offer prospective patients. In this way the patient can have a one-stop solution: education and information, provider recommendation/selection and financing arrangements.

As discussed above, third party promoter 600 can become the ambassador for dental implants to the general public. Third party promoter 600 can continually provide the best education, training and information about dental implant procedure and the professional service providers that work with them, and all within network 200. The services offered by third party promoter 600 can be sought and increase in popularity because network 200 can be a self-contained one-stop-shop for dental implants. As such, both the implant manufacturers and the dental specialists typically encourage and endorse third party promoter's 600 activities.

In a typical embodiment, the third party promoter 600 can refer implant procedures to both dental specialists and dental implant manufacturers, within network 200. Third party promoter 600 can establish relationships with the leading implant manufacturers. In one implementation, the third party promoter can build and promote its web site, conduct an extensive marketing campaign to educate and attract prospective patients,

Subsequently, third party promoter 600 can grow the annual number of patient referrals each year by maintaining and promoting the different developed networks among the parties. As such, third party promoter 600 can increase the annual growth rate of the dental implant market, add new and innovative services such as instant financing, develop a recognizable name and strong reputation, achieve excellent patient success by placing strong emphasis in the areas of outstanding service and support.

As discussed above, third party promoter 600 can become the de facto source of information to the public about dental implants. In general, third party promoter 600 can provide the following services to prospective patients: educational materials; toll-free access to an ‘expert’ who can answer all their questions; referrals of qualified providers within their area; financing options. Furthermore, to the dental professionals, third party promoter 600 can provide: education material about the use of implants it a dental practice; instructional training videos and material to the dentist's staff; qualified prospective patients. Finally, to the implant manufacturers, third party promoter 600 can provide: an increase in market awareness; increased sales to providers through its referral program.

Third party promoter 600 can establish relationships with the leading implant manufacturers that control a larger segment of the market. These relationships include: oral surgeons; restorative and aesthetic dental solutions providers of crowns, bridge and implant products as well as training, education and clinically documented treatment concepts; providers of implants and dental tissue regeneration; providers of implants, abutments and regenerative products.

In general, network 200 and third party promoter 600 can update and advance technology and education in the field of dentistry and cosmetic procedures through network 200 as demand increases. Such advanced technology in the field of dentistry and cosmetic procedures can include but are not limited to teeth whitening and porcelain veneers. Since an increasing number of patients are seeking out dentists who are able to provide aesthetic improvement for their teeth, this new generation of patients is willing to pay the necessary costs to improve their appearance. Such changing attitudes thereby increase the popularity of system 100, and therefore profits for groups 400, 500 within network 200. As discussed, as more new patients opt for dental implant procedures and cosmetic enhancements, dental specialists are forced to add to their technologies. Network 200 and third party promoter 600 can adapt with changing attitudes and technologies, particularly when larger populations of aging patients increases.

The third party promoter 600 can identify the following factors that can be used to favorably predispose potential customers to seek out the third party promoter's 600 expertise: education on the benefits of implants versus alternative options; brand recognition; reputation for impartiality; large base of service providers; knowledgeable staff; excellent service and support; excellent referrals, due to a large network of dental specialists and dental implant manufacturers.

The third party promoter's 600 marketing strategy generally focuses on the value that is provided through its services within network 200. Marketing efforts ware typically directed towards educating and informing the public about the benefits and advantages of dental implants and emphasizes the improved quality of life and security that consumer receives by choosing dental implants. Third party promoter 600 closely integrates all of its marketing and sales efforts to project a consistent brand image and a consistent positioning of products and services.

As described above, third party promoter 600 can employ a variety of marketing activities to fuel it customer acquisition process. These activities include but are not limited to: optimizing its website to describe and promote the business; TV commercials; TV Infomercials; Print advertising; taking out ads in trade related publications; web advertising (for example, pay-per-click); seminars; conducting seminars at various trade show and/or public events describing the benefits of dental implants; referrals; preparing testimonials and ‘white papers’ on the successful use and corresponding benefits by key customers. In another embodiment, third party promoter 600 can sell through direct and Internet distribution channels. In the direct channel, a call center professional who answers questions can be trained to guide the prospective patient make a decision and to select one of the service providers in its database. Patients may also sign up directly with a provider through the third party promoter's 600 website.

The software techniques and methods discussed above can be implemented in digital electronic circuitry, or in computer hardware, firmware (as discussed), software, or in combinations of them. Apparatus may be implemented in a computer program product tangibly embodied in a machine-readable storage device for execution by a programmable processor; and methods may be performed by a programmable processor executing a program of instructions to perform functions by operating on input data and generating output. Further embodiments may advantageously be implemented in one or more computer programs that are executable on a programmable system including at least one programmable processor coupled to receive data and instructions from, and transmit data and instructions, to a data storage system, at least one input device, and at least one output device. Each computer program may be implemented in machine language or assembly language which can be assembled or translated, or a high level procedural or object-oriented programming language, which can be complied or interpreted. Suitable processors include, by way of example, both general and special purpose microprocessors. Generally, a processor receives instructions and data from read-only memory and or RAM. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially designed application specific integrated circuits (ASICs).

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A method for promoting dental implant services, comprising:
identifying a group of dental patients requiring a dental service;
selecting a subset of the persons requiring the dental service who are candidates to receive dental implants;
distributing information relating to dental implants to the persons requiring the dental service; and
promoting the use of dental implants to the group of dental patients.

2. The method as claimed in claim 1 further comprising actively pursuing the subset of persons requiring the dental service who are candidates to receive dental implants.

3. The method as claimed in claim 1 wherein the dental service is the fitting of a crown.

4. The method as claimed in claim 1 wherein the dental service is the fitting of dentures.

5. The method as claimed in claim 1 wherein the dental service is veneer work.

6. The method as claimed in claim 1 further comprising identifying a group of dental specialists who are able to provide the dental service to the dental patients.

7. The method as claimed in claim 6 further comprising identifying a group of dental implant manufacturers who could provide dental implants to the group of dental patients and to the group of the specialists.

8. The method as claimed in claim 7 further comprising forming a network that can be accessed by the group of dental patients, the group of dental specialists and the group of dental implant manufacturers.

9. The method as claimed in claim 8 further comprising coordinating between the group dental implant manufacturers and the group of dental patients.

10. The method as claimed in claim 8 further comprising coordinating between the group dental implant manufacturers and the group of dental specialists.

11. The method as claimed in claim 8 further comprising coordinating between the group dental specialists and the group of dental patients.

12. A dental implant promotion system, comprising:
a network of dental specialists;
a network of dental implant manufacturers;
a network of dental patients;
a third party dental implant promoter,
wherein the third party promoter is for coordinating the network of dental specialists, the network of dental implant manufacturers, and
wherein the third party promoter is for coordinating the network of dental specialists and the network of dental patients.

13. The system as claimed in claim 12 wherein the third party dental implant promoter provides dental implant information to the network of dental patients.

14. The system as claimed in claim 13 wherein responses generated by a subset of the network of dental patients are received by the third party dental implant promoter.

15. The system as claimed in claim 14 wherein it is determined whether or not the subset of the network of dental patients is in need of dental implants.

16. The system as claimed in claim 15 wherein the third party promoter coordinates a visit between a subset of the network of dental specialists and the subset of dental patients.

17. The system as claimed in claim 16 wherein the subset of dental specialists determines the need for a dental implant for the subset of dental patients.

18. The system as claimed in claim 17 wherein the third party promoter can coordinate contact between the subset of dental specialists and a subset of dental implant manufacturers.

19. The system as claimed in claim 18 wherein the subset of dental specialists can receive a dental implant from the subset of the dental implant manufacturers to provide to the subset of dental patients in need of the dental implant.

20. The system as claimed in claim 13, wherein dental implant information is provided through a global network.

21. The system as claimed in claim 12 wherein the third party promoter can coordinate dental implant marketing between the network of dental patients and the network of dental implant manufacturers.

22. The system as claimed in claim 17 wherein coordinate communication between the network of dental patients and the network of dental specialists if the third party promoter determines a need in the network of dental patients for dental implants.

23. The system as claimed in claim 22 wherein the dental implants provided to the network of dental patients is provided from the network of dental manufacturers via the network of dental specialists.

24. The system as claimed in claim 12 wherein the third party promoter can coordinate enhanced communication between the network of dental patients and the network of dental specialists to promote the use of dental implants for the network of dental patients.

25. A method for promoting restorative dental services, comprising;
identifying a group of prospective patients who want restorative dental services;
selecting a subset of the group of prospective patients who want restorative dental services who qualify for a dental line of credit;
selecting a subset of the group of prospective patients who want restorative dental services who want implant supported dental services;
providing information about restorative dental services to the group of prospective patients who want restorative dental services;
providing interdependent dental network access to the group of prospective patients who want restorative dental services; and
promoting the use of implant supported dental services to the subset of the group of prospective patients who want implant supported dental services.

26. The method as claimed in claim 25 further comprising actively offering services to the group of prospective patients who want restorative dental services.

27. The method as claimed in claim 25 wherein the restorative dental service is selected from the group consisting of: related preparatory services, the orthodontic moving of a tooth, build-up of a tooth, reduction of a tooth to receive a removable appliance, and reduction of a tooth to receive a fixed appliance.

28. The method as claimed in claim 25 wherein the restorative dental service is the delivery of a fixed appliance selected from the group consisting of: a coping, an inlay, an onlay, a veneer, a crown or a bridge.

29. The method as claimed in claim 25 wherein the restorative dental service is the delivery of a removable appliance selected from the group consisting of: a partial denture, a complete denture, and an over-denture.

30. The method as claimed in claim 25 wherein the implant supported dental service comprises related preparatory services selected from the group consisting of: the placing of a dental implant, and subsequent fixation and preparation of an implant abutment to receive a fixed or removable appliance.

31. The method as claimed in claim 25 further comprising identifying a group of dentists who are qualified and able to provide restorative dental services to the subset of prospective patients who want restorative dental services.

32. The method as claimed in claim 25 further comprising identifying the group of dentists who are qualified and able to provide the implant supported dental services to the subset of prospective patients who want implant supported dental services.

33. The methods as claimed in claim 30 further comprising identifying a group of dental laboratories who are qualified and able to provide tooth supported or implant supported dental hardware to the groups of dentists and subsets of prospective patients who want restorative dental services.

34. The method as claimed in claim 31 further comprising identifying a group of dental core manufacturers who can provide dental core hardware to the group of dental laboratories, the groups of dentists and the subset of prospective patients who want restorative dental services.

35. The methods as claimed in claim 34 further comprising forming the interdependent dental network access to the subsets of prospective patients who want restorative and implant dental services, the groups of dentists who are qualified and able to provide restorative dental services, the group of dental laboratories who are qualified and able to provide dental restorative hardware, the group of dental core manufacturers who could provide dental core hardware, and the group of dental implant manufacturers who could provide dental implant hardware.

36. The method as claimed in claim 35 further comprising identifying a group of dental implant manufacturers who could provide dental implant hardware to the group of dental core manufacturers, the group of dental laboratories, the groups of dentists and the subset of the group of prospective patients who want implant supported dental services.

37. The method as claimed in claim 35 further comprising coordinating between the groups of prospective patients who want restorative dental services and the groups of dentists who are qualified and able to provide tooth supported or implant supported dental services.

38. The method as claimed in claim 35 further comprising coordinating between the groups of dentists and the group of dental core manufacturers.

39. The method as claimed in claim 35 further comprising coordinating between the groups of dentists and the groups of dental laboratories.

40. The method as claimed in claim 35 further comprising coordinating between the groups of dentists and the group of dental implant manufacturers.

41. The method as claimed in claim 35 further comprising coordinating between the group of dentists and the group of dental core manufacturers.

42. The method as claimed in claim 35 further comprising coordinating between the group of dental core manufacturers and the group of dental laboratories.

43. The method as claimed in claim 35 further comprising coordinating between the group of dental laboratories and the group of dental implant manufacturers.

44. A dental restorative and dental implant promotion system, comprising:
a network of dental implant manufacturers;
a network of dental core manufacturers;
a network of dental laboratories;
a network of dentists;
a network of dental line of credit lenders;
a network of prospective patients;
a third party restorative and implant supported dental service promoter,
wherein the third party promoter is for coordinating the network of dentists, the network of dental laboratories, the network of dental core manufacturers, the network of dental implant manufacturers,
wherein the third party promoter is for coordinating training of the network of dentists, the network of dental laboratories, and
wherein the third party promoter is for coordinating the network of dentists and the network of prospective patients.

45. The system as claimed in claim 44 wherein the third party dental implant promoter provides dental restorative and dental implant information to the network of prospective patients.

46. The system as claimed in claim 45 wherein the responses generated by the subsets of the network of prospective patients are received by the third party dental restorative and dental implant promoter.

46. The system as claimed in claim 46 wherein the third party promoter coordinates a review of credit worthiness between the network of dental line of credit lenders and a prospective patient from the network of prospective patients.

47. The system as claimed in claim 46 wherein the third party promoter and the network of dental line of credit lenders issue a patient network credit card, respectively to a prospective patient from the network of prospective patients.

48. The system as claimed in claim 46 wherein the third party promoter coordinates visits between the network of dentists and the prospective patient.

49. The system as claimed in claim 48 wherein the network of dentists determines a need for dental restoration and dental implants for the prospective patient.

50. The system as claimed in claim 48 wherein the prospective patient selects a dentist from the network of dentists.

51. The system as claimed in claim 50 wherein the dentist presents alternative treatment plans for the prospective patient.

52. The system as claimed in claim 48 wherein the patient accepts a treatment plan presented by the dentist.

53. The system as claimed in claim 48 wherein the prospective patient swipes the patient network credit card at the office of the dentist.

54. The system as claimed in claim 52 wherein the third party promoter coordinates between the network of dentists and the network of dental laboratories.

55. The system as claimed in claim 53 wherein the third party promoter and the network of dental line of credit lenders issue the network of dentist a dentist network credit card that is valid for purchases exclusively within the network.

56. The system as claimed in claim 52 wherein the third party promoter coordinates contact between the network of dental laboratories and the network of dental implant manufacturers.

57. The system as claimed in claim 56, wherein the third party promoter and the network of dental line of credit lenders issue the network of dental laboratories a dental laboratory network credit card valid for purchases exclusively within the network.

58. The system as claimed in claim 52 wherein the third party promoter coordinates contact between the network of dentists and the network of dental core manufacturers.

59. The system as claimed in claim 52 wherein the third party promoter can coordinate contact between the network of dentists and the network of dental implant manufacturers

60. The system as claimed in claim 52 wherein the dentists specifies and pays for dental implant hardware from a network dental implant manufacturer providing the hardware to the dentists treating the patient.

61. The system as claimed in claim 60 wherein the dentists uses the network credit card to specify and pay for dental implant hardware from a network dental implant manufacturer providing dental implant hardware to the dentist treating the patient.

62. The system as claimed in claim 53 wherein the dentist can specify and pay for dental restorative hardware from a network dental laboratory providing the hardware to the dentist treating the patient.

63. The system as claimed in claim 62 wherein the dentist can use the dentist network credit card to specify and pay for dental restorative hardware from a network dental laboratory providing the hardware to the dentist treating the patient.

64. The system as claimed in claim 53 wherein the dentist can specify and pay for dental core hardware used by a network dental laboratory providing dental restorative hardware to the dentist treating the patient.

65. The system as claimed in claim 64 wherein the dentist uses the network dentist credit card to specify and pay for dental core hardware used by the network dental laboratory providing dental restorative hardware to the dentist treating the patient.

66. The system as claimed in claim 53 wherein the network dental laboratory specifies and pays for dental implant abutment hardware from a network dental implant manufacturer providing the hardware to the laboratory and the dentist treating the patient.

67. The system as claimed in claim 66 wherein the network dental laboratory uses the dental laboratory network credit card to specify and pay for dental implant abutment hardware from a network dental implant manufacturer providing the hardware to the laboratory and the dentist treating the patient.
